(19) United States
(12) Patent Application Publication
(10) Pub. No.: US 2013/0346962 A1
(43) Pub. Date: Dec. 26, 2013

(54) MECHANISM AND SYSTEM FOR DEPLOYING SOFTWARE OVER CLOUDS

(71) Applicants: Tien-Chin FANG, Taoyuan County (TW); Chen-Chung Lee, Nantou County (TW); Chun-Hung Chen, New Taipei City (TW); Ta-Feng Teng, Kaohsiung City (TW); Meng-Yu Li, Taipei City (TW); Chia-Chen Chiang, Taoyuan County (TW); Yu-Jen Lin, New Taipei City (TW)

(72) Inventors: Tien-Chin FANG, Taoyuan County (TW); Chen-Chung Lee, Nantou County (TW); Chun-Hung Chen, New Taipei City (TW); Ta-Feng Teng, Kaohsiung City (TW); Meng-Yu Li, Taipei City (TW); Chia-Chen Chiang, Taoyuan County (TW); Yu-Jen Lin, New Taipei City (TW)

(73) Assignee: Quanta Computer Inc., Tao Yuan Shien (TW)

(21) Appl. No.: 13/593,978

(22) Filed: Aug. 24, 2012

(30) Foreign Application Priority Data
Jun. 26, 2012 (TW) 101122797

(51) Int. Cl. G06F 9/445

(52) U.S. Cl. 717/175

(57) ABSTRACT

A mechanism for deploying software over clouds is provided. The mechanism comprises the following steps. A source cloud platform stores a software project and builds up an environmental transfer configuration. The source cloud platform collects the settings of the software project and related resources to obtain a list file, and a target cloud platform receives the list file and assigns a corresponding data transmission status as un-transmitted. When the data transmission status is un-transmitted, the target cloud platform requests the source cloud platform for the software project. The source cloud platform transmits the software project to the target cloud platform. When the target cloud platform confirms that the software project has been received completely according to the list file, the target cloud platform accordingly installs the software project and builds up related resources.

This application claims the benefit of Taiwan application Serial No. 101122797, filed Jun. 26, 2012, the subject matter of which is incorporated herein by reference.

### BACKGROUND OF THE INVENTION

1. Field of the Invention

The invention relates in general to a mechanism and a system for deploying software over clouds.

2. Description of the Related Art

Along with the development in the information technology, software has become indispensable to either the individual or the business. Furthermore, cloud computing service provides various possibilities for service orientated software. However, currently the programmer can only develop and provide software service on the same cloud platform.

If the programmer wants to deploy the developed software project on the cloud platform of the cloud software service provider (such as telecommunication operators), then the service provider must establish the same environment comprising providing the development unrelated to operation and testing resources. Then, the programmer must manually transmit the software project and related files to the cloud platform of the service provider and then installs the software project to the web server. The programmer performs setting in the web server, and builds up account for the software project to separate the operations of the system. Then, the programmer establishes the required resources (such as database, file system and related access authority) for the software project and stores the setting of the software project.

The above manual environment transfer procedure increases system establishment cost, and the programmer must manually transfer the software project to be deployed on the cloud platform of service provider. Human caused errors may easily occur during the complicated process, and make the software project to operate normally with the new cloud platform.

### SUMMARY OF THE INVENTION

The invention is directed to a mechanism and a system for deploying software over clouds, which automatically transfer the software project to another cloud platform and promptly deploy the entire software project for operation.

According to an embodiment of the present invention, a mechanism for deploying software over clouds is provided. The mechanism comprises the following steps. A source cloud platform stores a software project and builds up an environmental transfer configuration. The source cloud platform collects the settings of the software project and related resources to obtain a list file, and a target cloud platform receives the list file and assigns a corresponding data transmission status as un-transmitted. When the data transmission status is un-transmitted, the target cloud platform requests the source cloud platform for the software project. The source cloud platform transmits the software project to the target cloud platform. When the target cloud platform confirms that the software project has been received completely according to the list file, the target cloud platform accordingly installs the software project and builds up related resources.

According to another embodiment of the present invention, a system for deploying software over clouds is provided. The system comprises a source cloud platform and a target cloud platform. The source cloud platform comprises a source environment module, a source communication module and a source file module. The source environment module stores a software project and builds up an environmental transfer configuration. The source communication module collects the settings of the software project and related resources to obtain a list file, and outputs the list file. The target cloud platform comprises a target communication module, a target file module and a target deployment module. The target communication module receives the list file and assigns a corresponding data transmission status as un-transmitted. When data transmission status is un-transmitted, the target file module requests the source file module for the software project, receives the software project from the source file module, and confirms whether the software project has been completely received according to the list file. When the target file module confirms that the software project has been received completely, the target deployment module installs the software project and builds up related resources.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a system for deploying software over clouds according to an embodiment;

FIG. 2 shows a flowchart of a mechanism for deploying software over clouds according to an embodiment.

### DETAILED DESCRIPTION OF THE INVENTION

The disclosure provides a mechanism and a system for deploying software over clouds which enable the settings of the software project and related resources to be automatically transferred to another cloud platform and promptly deploy the entire software project for operation so as to save time and reduce cost.

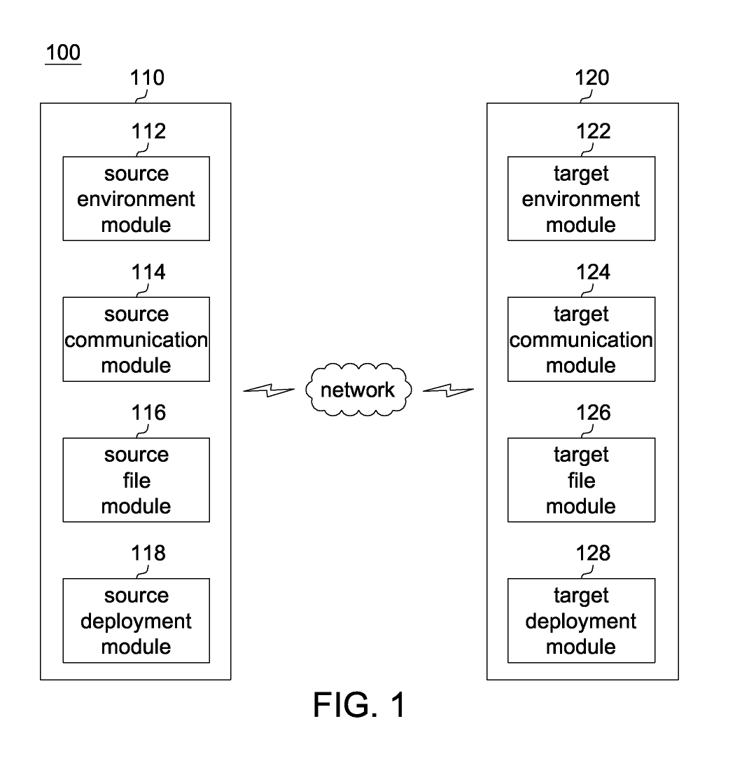

Referring to FIG. 1, a system for deploying software over clouds according to an embodiment is shown. As exemplified in FIG. 1, the system for deploying software over clouds 100 comprises 2 cloud platforms, but the disclosure is not limited thereto. The system for deploying software over clouds 100 comprises a source cloud platform 110 and a target cloud platform 120. The source cloud platform refers to the cloud platform via which the programmer uploads a software project. The target cloud platform refers to the cloud platform on which the software project is deployed. The cloud platforms adopt the mechanism for deploying software over clouds of the disclosure.

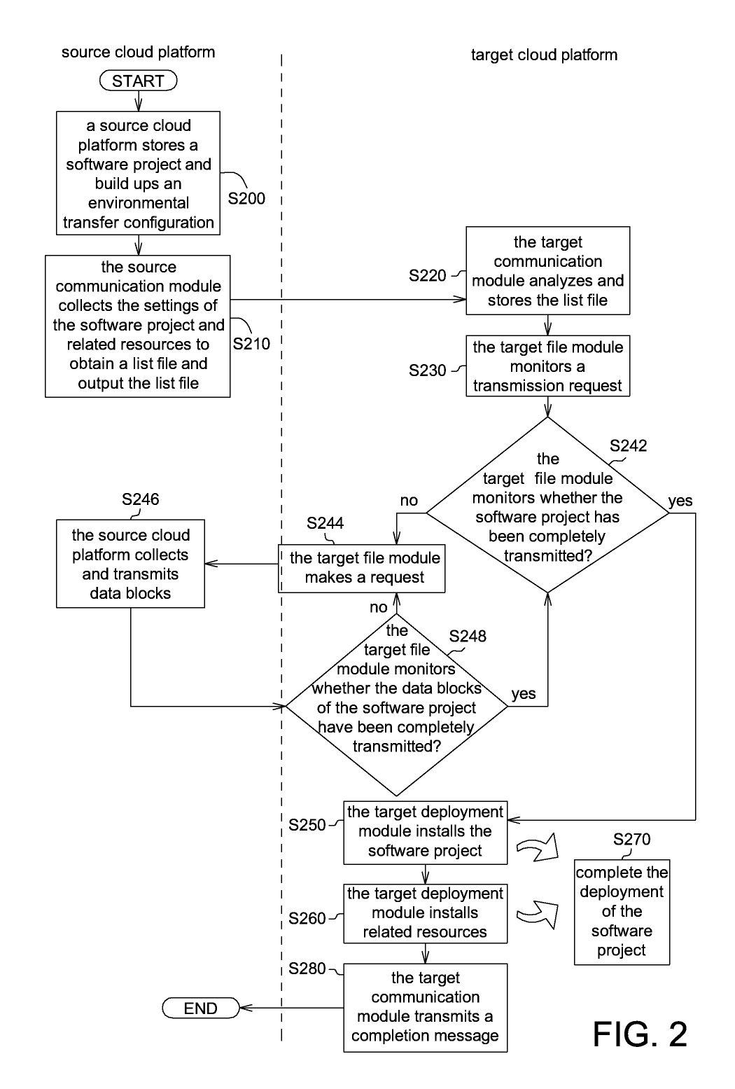

As indicated in FIG. 1, the source cloud platform 110 communicates with the target cloud platform 120 through a network. The source cloud platform 110 comprises a source environment module 112, a source communication module 114, a source file module 116 and a source deployment module 118. The target cloud platform 120 comprises a target environment module 122, a target communication module 124, a target file module 126 and a target deployment module 128. A mechanism for deploying software over clouds between the source cloud platform 110 and the target cloud platform 120 is illustrated in FIG. 2. Referring to FIG. 2, a flowchart of a mechanism for deploying software over clouds according to an embodiment is shown.

In step S200, the programmer uploads the developed software project to the source cloud platform 110, and the source environment module 112 stores the software project to the database of the source cloud platform 110 and builds on an environmental transfer configuration, wherein the environmental transfer configuration comprises a version selection of the new environment (referring to the target cloud platform 120 in the present embodiment) to transfer to and the software project. In step S210, the source communication module 114 collects the settings of the software project and related resources to obtain a list file, such as an extensible markup language (XML) format, and calls the target communication module 124 to output the list file.

In step S220, the target communication module 124, after receiving the list file, analyzes and stores the list file to the database of the target cloud platform 120. Meanwhile, the target communication module 124 assigns a data transmission status corresponding to the file list as “un-transmitted”. In step S230, the target file module 126 monitors the data transmission status corresponding to the list file as “un-transmitted”. That is, the target file module 126 monitors a transmission request. Therefore, the target file module 126 requests the source file module 116 for the software project according to the list file.

In the embodiment, the message transmission optimization mechanism (MTOM) is used in the resuming technology, but the disclosure is not limited thereto. In step S242, the target file module 126 monitors whether the software project has been completely transmitted according to the list file. If no, the process proceeds to step S244, the target file module 126 requests the source file module 126. In step S246, the source file module 116 divides the software project into a plurality of data blocks, and transmits the data blocks to the target file module 126.

In step S248, the target file module 126 monitors whether the data blocks of the software project have been completely transmitted. If no, then the process returns to step S244. If the data blocks of the software project have been completely transmitted, then the process returns to step S242, the target file module 126 monitors whether the software project have been completely transmitted. When all data blocks of the software project are received, the data transmission status is changed as transmitted.

When the target file module 126 confirms that the software project has been received completely according to the list file, in step S250, the target deployment module 128 installs the software project to a web server at which the target cloud platform 120 resides. The target deployment module 128 performs related settings (such as environment setting or authority setting) in the web server according to the data of the source cloud platform 110. Then, the process proceeds to step S260, the target deployment module 128 installs related resources (such as database and file system) required for establishing the software project.

In step S270, the software project is deployed on the target cloud platform 120. If the software project needs to be transferred to another cloud platform, then the above step of deploying the target cloud platform is repeated. After the software project is deployed, the process proceeds to step S280, the target communication module 124 transmits a completion message to the source cloud platform 110 or the programmer.

The disclosure provides a mechanism and a system for deploying software over clouds which enable the settings of the software project and related resources to be automatically transferred to another cloud platform and promptly deploy the entire software project for operation so as to save time, reduce cost and avoid human caused errors. Besides, by using the MTOM resuming technology on the settings of the software project and related resources, data transfer between the cloud platforms can be completed in a time-saving manner.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A mechanism for deploying software over clouds, comprising:
using a source cloud platform to store a software project and build up an environmental transfer configuration;
using the source cloud platform to collect the settings of the software project and related resources to obtain a list file, and using a target cloud platform to receive the list file and assign a corresponding data transmission status as un-transmitted;
using the target cloud platform to request the source cloud platform for the software project when the data transmission status is un-transmitted;
using the source cloud platform to transmit the software project to the target cloud platform; and
using the target cloud platform to accordingly install the software project and build up related resources according to the list file when the target cloud platform confirms that the software project has been received completely.

2. The mechanism for deploying software over clouds according to claim 1, wherein the environmental transfer configuration comprises a version selection of the target cloud platform and the software project.

3. The mechanism for deploying software over clouds according to claim 1, wherein the list file is an XML format.

4. The mechanism for deploying software over clouds according to claim 1, further comprising:
using the target cloud platform to analyze and store the list file when receiving the list file.

5. The mechanism for deploying software over clouds according to claim 1, further comprising:
using the target cloud platform to monitor the data transmission status;
using the target cloud platform to request the source cloud platform for the software project according to the list file when the data transmission status is un-transmitted;
using the source cloud platform to divide the software project into a plurality of data blocks and transmit the data blocks to the target cloud platform; and
using the target cloud platform to change the data transmission status as transmitted when the target cloud platform monitors that the data blocks have been received.

6. The mechanism for deploying software over clouds according to claim 1, further comprising:
using the target cloud platform to transmit a completion message when the target cloud platform has installed the software project to a web server at which the target cloud platform resides and has built up related resources of the software project.

7. A system for deploying software over clouds, comprising:
a source cloud platform, comprising:
a source environment module used for storing a software project and building up an environmental transfer configuration;
a source communication module used for collecting the settings of the software project and related resources to obtain a list file and outputting the list file; and
a source file module; and
a target cloud platform, comprising:
a target communication module used for receiving the list file and assigning a corresponding data transmission status as un-transmitted;
a target file module used for requesting the source file module for the software project block when the data transmission status is un-transmitted, receiving the software project block from the source file module and confirming whether the software project blocks have been completely received according to the list file; and
a target deployment module used for installing the software project and building up related resources when the target file module confirms that the software project blocks have been completely received.

8. The system for deploying software over clouds according to claim 7, wherein the environmental transfer configuration comprises a version selection of the target cloud platform and the software project.

9. The system for deploying software over clouds according to claim 7, wherein the list file is an XML format.

10. The system for deploying software over clouds according to claim 7, wherein the target communication module analyzes and stores the list file when receiving the list file.

11. The system for deploying software over clouds according to claim 7, wherein:
the target file module monitors the data transmission status;
the target file module requests the source file module for the software project according to the list file when the data transmission status is un-transmitted;
the source file module divides the software project into a plurality of data blocks, and transmits the data blocks to the target file module;
the target file module changes the data transmission status as transmitted when the target file module monitors that the data blocks have been received.

12. The system for deploying software over clouds according to claim 7, wherein the target communication module transmits a completion message when the target deployment module has installed the software project to a web server at which the target cloud platform resides and has built up related resources of the software project.
